(19) United States
(12) Patent Application Publication
(10) Pub. No.: US 2019/0306000 A1
(43) Pub. Date: Oct. 3, 2019

(54) Data Transmission Method and Apparatus

(71) Applicant: Huawei Technologies Co., Ltd., Shenzhen (CN)

(72) Inventors: Xiangming Meng, Shanghai (CN); Yan Chen, Shanghai (CN); Yiqun Wu, Shanghai (CN); Alireza Bayesteh, Ottawa-Kanata (CA)

(21) Appl. No.: 16/444,196

(22) Filed: Jun. 18, 2019

Related U.S. Application Data
(63) Continuation of application No. PCT/CN2017/117448, filed on Dec. 20, 2017.

(30) Foreign Application Priority Data
Jan. 5, 2017 (CN) 201710008129.0

(51) Int. Cl. H04L 27/26; H04L 27/06

(52) U.S. Cl. CPC H04L 27/2692; H04L 27/2613; H04L 27/06

(57) ABSTRACT

A data transmission method and device, the method including receiving, by a network device, first data sent by a first terminal device on a multiplexing resource, wherein the first data is generated according to a first multiple access signature (MAS), receiving, by the network device, second data sent by a second terminal device on the multiplexing resource, wherein the second data is generated according to a second MAS, and wherein the first MAS and the second MAS have at least one of different demodulation reference signals (DMRSs) or different preamble sequences, and detecting, by the network device, from the multiplexing resource, according to the first MAS and the second MAS, the first data and the second data that are sent on the multiplexing resource.

### CROSS-REFERENCE TO RELATED APPLICATIONS

This application is a continuation of International Application No. PCT/CN2017/117448, filed on Dec. 20, 2017, which claims priority to Chinese Patent Application No. 201710008129.0, filed on Jan. 5, 2017. The disclosures of the aforementioned applications are hereby incorporated by reference in their entireties.

### TECHNICAL FIELD

Embodiments of this application relate to the communications field, and in particular, to a data transmission method and apparatus in the communications field.

### BACKGROUND

Enhanced mobile broadband (eMBB) and ultra-reliable and low latency communications (URLLC) are two important scenarios in a future network system. Compared with an existing mobile broadband service scenario, the eMBB further improves performance such as a system capacity, and enhances user experience. The eMBB corresponds to a high-traffic mobile broadband service such as a 3D/ultra-high definition video. For services such as Internet of Vehicles, unmanned driving, and industrial control, the system capacity is no longer a major issue, but a quite high requirement is imposed on latency and reliability. The URLLC can meet such the requirement for a low-latency and high-reliability communications service. Because of limited available resources, if an eMBB terminal device and a URLLC terminal device simultaneously send data on a same physical resource, it is difficult for a network device to detect the data sent by the two terminal devices. Consequently, data transmission performance is relatively poor.

### SUMMARY

Embodiments of this application provide a data transmission method and apparatus, so as to improve data transmission performance.

According to a first aspect, a data transmission method is provided. The method includes receiving, by a network device, first data sent by a first terminal device on a multiplexing resource, where the first data is generated based on a first multiple access signature (MAS), receiving, by the network device, second data sent by a second terminal device on the multiplexing resource, where the second data is generated based on a second MAS, and the first MAS and the second MAS include different demodulation reference signals (DMRS) and/or different preamble sequences, and detecting, by the network device based on the first MAS and the second MAS, the first data and the second data that are sent on the multiplexing resource.

In this embodiment of this application, the first data is generated by using the first MAS, and the second data is generated by using the second MAS. In this way, when the network device simultaneously receives the first data and the second data on the multiplexing resource, the network device may jointly detect the first data and the second data by using the first MAS and the second MAS, so as to improve data transmission performance.

Optionally, the first terminal device may be an eMBB terminal device, and the second terminal device may be a URLLC terminal device. Alternatively, the first terminal device may be an eMBB terminal device, and the second terminal device may be an eMBB terminal device. Alternatively, the first terminal device may be a URLLC terminal device, and the second terminal device may be an eMBB terminal device. Alternatively, the first terminal device may be a URLLC terminal device, and the second terminal device may be a URLLC terminal device. Alternatively, the first terminal device and the second terminal device may be terminal devices of another type. This is not limited in this embodiment of this application.

Optionally, in addition to the different DMRSs and/or the different preamble sequences, the first MAS and the second MAS each may further include at least one of the following five items, including a codebook (or a codeword), a sequence, an interleaver pattern, a mapping pattern, a spatial dimension, and a power dimension. The first MAS and the second MAS may be the same or different in at least one of the five items. This is not limited in this embodiment of this application.

Optionally, the network device receives combined data on the multiplexing resource. The combined data includes the first data and the second data, the first data is generated based on the first MAS, the second data is generated based on the second MAS, and the first MAS and the second MAS include the different DMRSs and/or the different preamble sequences. The network device detects, based on the first MAS and the second MAS, the combined data sent on the multiplexing resource, to obtain the first data and the second data. Further, the network device may determine that the combined data received on the multiplexing resource is from the first terminal device and the second terminal device.

In some implementations, before the receiving, by a network device, first data sent by a first terminal device on a multiplexing resource, the method further includes determining, by the network device, the first MAS of the first terminal device.

In this embodiment of this application, the first MAS of the first terminal device that is determined by the network device may be generated by the first data by using the first MAS, where the first data is sent by the first terminal device, or the first MAS determined by the network device may be generated by all data by using the first MAS, where all the data is sent by the first terminal device.

In some implementations, the determining, by the network device, the first MAS of the first terminal device includes receiving, by the network device, a first DMRS and/or a first preamble sequence that are/is sent by the first terminal device, and determining, by the network device, the first MAS based on the first DMRS and/or the first preamble sequence and a first mapping relationship, where the first mapping relationship is used to indicate a correspondence between a MAS and a DMRS and/or a preamble sequence that are/is sent by the first terminal device.

Optionally, when sending the first preamble sequence, the first terminal device may send the first preamble sequence before the first data, or when sending the first DMRS, the first terminal device may simultaneously send the first DMRS and the first data to the network device. When sending the first DMRS and the first preamble sequence, the first terminal device may send the first preamble sequence before the first DMRS and the first data, or may send the first preamble sequence and the first DMRS before the first data. A manner of sending the first preamble sequence, the first DMRS, and the first data is not limited in this embodiment of this application.

In some implementations, the method further includes sending, by the network device, first indication information to the first terminal device, where the first indication information is used to instruct the first terminal device to send the data by using the first MAS in a first MAS set.

In this embodiment of this application, the first terminal device may work in an authorization mode, to be specific, the first terminal device determines the first MAS in the first MAS set, may receive the first indication information sent by the network device, and determines the first MAS in the first MAS set according to the first indication information.

Optionally, the protocol may specify that the first terminal device uses the first MAS in the first MAS set, or the network device may instruct the first terminal device to use the first MAS in the first MAS set.

In some implementations, before the sending, by the network device, first indication information to the first terminal device, the method further includes sending, by the network device, second indication information to the first terminal device, where the second indication information is used to indicate the first MAS set.

In some implementations, before the receiving, by the network device, second data sent by a second terminal device on the multiplexing resource, the method further includes determining, by the network device, the second MAS of the second terminal device.

In this embodiment of this application, the second MAS of the second terminal device that is determined by the network device may be generated by the second data by using the second MAS, where the second data is sent by the second terminal device, or the second MAS determined by the network device may be generated by all data by using the second MAS, where all the data is sent by the second terminal device.

In some implementations, the determining, by the network device, the second MAS of the second terminal device includes receiving, by the network device, a second DMRS and/or a second preamble sequence that are/is sent by the second terminal device, and determining, by the network device, the second MAS based on the second DMRS and/or the second preamble sequence and a second mapping relationship, where the second mapping relationship is used to indicate a correspondence between a MAS and a DMRS and/or a preamble sequence that are/is sent by the second terminal device.

Optionally, when sending the second preamble sequence, the second terminal device may send the second preamble sequence before the second data, or when sending the second DMRS, the second terminal device may simultaneously send the second DMRS and the second data to the network device. When sending the second DMRS and the second preamble sequence, the second terminal device may send the second preamble sequence before the second DMRS and the second data, or may send the second preamble sequence and the second DMRS before the second data. A manner of sending the second preamble sequence, the second DMRS, and the second data is not limited in this embodiment of this application.

In some implementations, the method further includes sending, by the network device, third indication information to the second terminal device, where the third indication information is used to instruct the second terminal device to send the data by using the second MAS in a second MAS set.

In this embodiment of this application, the second terminal device may work in an authorization mode, to be specific, the second terminal device determines the second MAS in the second MAS set, may receive the second indication information sent by the network device, and determines the second MAS in the second MAS set according to the second indication information.

Optionally, the protocol may specify that the second terminal device uses the second MAS in the second MAS set, or the network device may instruct the second terminal device to use the second MAS in the second MAS set.

In some implementations, before the sending, by the network device, third indication information to the second terminal device, the method further includes sending, by the network device, fourth indication information to the second terminal device, where the fourth indication information is used to indicate the second MAS set.

In some implementations, before the receiving, by a network device, first data sent by a first terminal device on a multiplexing resource, the method further includes determining, by the network device, the multiplexing resource, and sending, by the network device, fifth indication information to the first terminal device, where the fifth indication information is used by the first terminal device to determine the multiplexing resource, and/or sending, by the network device, sixth indication information to the second terminal device, where the sixth indication information is used by the second terminal device to determine the multiplexing resource.

In this embodiment of this application, the multiplexing resource determined by the first terminal device and the second terminal device may be indicated by respectively sending the fifth indication information and the sixth indication information to the first terminal device by the network device, the first terminal device determines the multiplexing resource according to the fifth indication information, and the second terminal device determines the multiplexing resource according to the sixth indication information.

Optionally, the multiplexing resource may not be determined and indicated by the network device, in other words, the multiplexing resource determined by the first terminal device and the second terminal device may be a fixed multiplexing resource specified in the protocol. This is not limited in this embodiment of this application.

In some implementations, the fifth indication information is used to indicate, to the first terminal device, that a first physical resource is the multiplexing resource, and the sixth indication information is used to indicate, to the second terminal device, that the first physical resource is the multiplexing resource.

In some implementations, the first terminal device can send the data on all physical resources, and/or the second terminal device can send the data on all physical resources.

In other words, the fifth indication information may directly indicate, to the first terminal device, that the first physical resource is the multiplexing resource, and the sixth indication information may directly indicate, to the second terminal device, that the first physical resource is the multiplexing resource. More specifically, when the first terminal device is an eMBB terminal device, the eMBB terminal device may occupy all the physical resources by default. When receiving the fifth indication information sent by the network device, the eMBB terminal device may determine that the first physical resource is the multiplexing resource, and the remaining physical resources other than the first physical resource are dedicated resources of the eMBB terminal device. In this way, the eMBB terminal device may use different coding manners for data sent on the multiplexing resource and data sent on the dedicated resources. For example, the eMBB terminal device may send the data on the multiplexing resource by using one MAS, and send the data on the dedicated resources by using another MAS. A MAS used to send the data on the multiplexing resource is different from a MAS used to send the data on the dedicated resources. Further, the network device may indicate, to the first terminal device, a MAS used by the second terminal device to send the data on the multiplexing resource. In this way, when selecting a MAS, the terminal device may avoid the MAS of the second terminal device, and select a MAS different from that of the second terminal device to send the data. Likewise, the second terminal device may be a URLLC terminal device, and the URLLC terminal device may occupy all the physical resources by default. When receiving the fifth indication information sent by the network device, the URLLC terminal device may determine that the first physical resource is the multiplexing resource, and the remaining physical resources other than the first physical resource are dedicated resources of the URLLC terminal device. In this way, the URLLC terminal device may use different coding manners for data sent on the multiplexing resource and data sent on the dedicated resources.

In some implementations, the fifth indication information is further used to indicate, to the first terminal device, that a physical resource of the second terminal device is a first physical resource, and indicates that the first terminal device can send the data by using the physical resource of the second terminal device, and the first physical resource is the multiplexing resource.

In this embodiment of this application, the first terminal device and the second terminal device may use different physical resources by default. However, the first terminal device sends the data on the physical resource of the second terminal device, and therefore the physical resource of the second terminal device is the multiplexing resource. The fifth indication information may indicate, to the first terminal device, that the physical resource of the second terminal device is the first physical resource, and indicate that the first terminal device can send the data by using the physical resource of the second terminal device, and the physical resource of the second terminal device is the multiplexing resource. The protocol may specify that the first terminal device determines the multiplexing resource by using the indication, and the resource of the second terminal device is the multiplexing resource. In this way, the second terminal device may determine the multiplexing resource without using the indication.

In some implementations, the sixth indication information is used to indicate, to the second terminal device, that a physical resource of the first terminal device is a first physical resource, and indicates that the second terminal device can send the data by using the physical resource of the first terminal device, and the first physical resource is the multiplexing resource.

In this embodiment of this application, the sixth indication information may indicate, to the second terminal device, that the physical resource of the first terminal device is the first physical resource, and indicate that the second terminal device can send the data by using the physical resource of the first terminal device, and the physical resource of the first terminal device is the multiplexing resource. The protocol may specify that the second terminal device determines the multiplexing resource by using the indication, and the resource of the first terminal device is the multiplexing resource. In this way, the first terminal device may determine the multiplexing resource without using the indication.

In some implementations, the detecting, by the network device based on the first MAS and the second MAS, the first data and the second data that are sent on the multiplexing resource includes detecting, by the network device based on the first MAS and the second MAS by using a message passing algorithm (message passing algorithm, MPA), the first data and the second data that are sent on the multiplexing resource.

In this embodiment of this application, the network device may detect, based on the first MAS and the second MAS by using the MPA, the first data and the second data that are sent on the multiplexing resource, or may certainly detect, by using another algorithm, the first data and the second data that are sent on the multiplexing resource. This is not limited in this embodiment of this application.

In some implementations, the first terminal device is an enhanced mobile broadband eMBB terminal device, and the second terminal device is an ultra-reliable and low latency communications URLLC terminal device.

In this way, the eMBB terminal device needs to occupy a relatively large quantity of resources while increasing a system capacity, for example, may occupy all the physical resources. When the URLLC terminal device sends the data on some physical resources, a DMRS in the MAS used by the eMBB terminal device is different from a DMRS in the MAS used by the URLLC terminal device, and/or a preamble sequence in the MAS used by the eMBB terminal device is different from a preamble sequence in the MAS used by the URLLC terminal device. In this way, the network device may detect the first data and the second data that are received on the multiplexing resource. Therefore, data transmission performance can be improved while a key performance indicator of the URLLC terminal device is met.

According to a second aspect, a data transmission method is provided. The method includes determining, by a first terminal device, a first multiple access signature MAS for sending first data, and sending, by the first terminal device, the first data to a network device on a multiplexing resource between the first terminal device and a second terminal device based on the first MAS, where a second MAS of the second terminal device and the first MAS include different demodulation reference signals DMRSs and/or different preamble sequences.

In this embodiment of this application, the first terminal device sends the first data on the multiplexing resource, and the first MAS for generating the first data and the second MAS of the second terminal device include the different DMRSs and/or the different preamble sequences. The second terminal device transmits data by using the second MAS, and the two different terminal devices send data on a same resource. When the network device may receive the first data and the second data on the same resource, the network device may detect the first data and the second data based on the first MAS and the second MAS, so as to improve data transmission performance.

Optionally, the sending, by the first terminal device, the first data to a network device on a multiplexing resource between the first terminal device and a second terminal device based on the first MAS includes generating, by the first terminal device, the first data based on the first MAS, and sending the first data on the multiplexing resource.

Optionally, the first terminal device may be an eMBB terminal device, and the second terminal device may be a URLLC terminal device. Alternatively, the first terminal device may be a URLLC terminal device, and the second terminal device may be an eMBB terminal device.

Optionally, the determining, by a first terminal device, a first MAS includes determining, by the first terminal device, the first MAS in a first MAS set, where the first MAS set may be a MAS set specified in the protocol, or the first MAS set may be a first MAS set that the network device instructs, by using second indication information, the first terminal device to use.

In some implementations, before the determining, by a first terminal device, a first multiple access signature MAS for sending first data, the method further includes receiving, by the first terminal device, second indication information sent by the network device, where the second indication information is used to indicate a first MAS set, and the determining, by a first terminal device, a first multiple access signature MAS for sending first data includes determining, by the first terminal device, the first MAS set according to the second indication information, and determining, by the first terminal device, the first MAS in the first MAS set.

In this embodiment of this application, the first MAS set may include a plurality of MASs, and the MASs are different from each other. Each MAS includes a DMRS and/or a preamble sequence and at least one element. For example, the at least one element may be a codebook (or a codeword), a sequence, an interleaver pattern, a mapping pattern, a spatial dimension, and a power dimension.

In some implementations, the determining, by the first terminal device, the first MAS in the first MAS set includes receiving, by the first terminal device, first indication information sent by the network device, where the first indication information is used by the first terminal device to send the data by using the first MAS in the first MAS set, and the determining, by the first terminal device, the first MAS in the first MAS set includes determining, by the first terminal device, the first MAS in the first MAS set according to the first indication information.

In some implementations, the determining, by the first terminal device, the first MAS in the first MAS set includes determining, by the first terminal device, the first MAS based on identification information of the first terminal device and a MAS sequence number in the first MAS set.

In this embodiment of this application, the first terminal device may work in an authorization mode and an authorization-free mode, and a manner in which the terminal device determines the first MAS in the first MAS set may vary with a working mode. For example, when the first terminal device works in the authorization mode, the first terminal device receives the first indication information sent by the network device by using downlink control information, and determines the first MAS in the first MAS set according to the first indication information. When the first terminal device works in the authorization-free mode, the first terminal device determines the first MAS by using the MAS sequence number in the first MAS set and the identification information of the first terminal device.

In some implementations, before the sending, by the first terminal device, the first data to a network device on a multiplexing resource between the first terminal device and a second terminal device based on the first MAS, the method includes determining, by the first terminal device, the multiplexing resource.

In this embodiment of this application, the multiplexing resource determined by the first terminal device may be a multiplexing resource specified in the protocol, or may be a multiplexing resource indicated by the network device by using fifth indication information. For example, the protocol specifies that a first physical resource is the multiplexing resource, and the first terminal device and the second terminal device may simultaneously send data on the first physical resource.

In some implementations, the determining, by the first terminal device, the multiplexing resource includes receiving, by the first terminal device, fifth indication information sent by the network device, and determining, by the first terminal device, the multiplexing resource according to the fifth indication information.

In some implementations, the fifth indication information is used to indicate, to the first terminal device, that a first physical resource is the multiplexing resource, and the determining, by the first terminal device, the multiplexing resource according to the fifth indication information includes determining, by the first terminal device according to the fifth indication information, that the first physical resource is the multiplexing resource.

In some implementations, the first terminal device can send the data on all physical resources, and/or the second terminal device can send data on all physical resources.

In some implementations, the fifth indication information is further used to indicate, to the first terminal device, that a physical resource of the second terminal device is a first physical resource, and indicates that the first terminal device can send the data by using the physical resource of the second terminal device, and the first physical resource is the multiplexing resource.

According to a third aspect, a data transmission apparatus is provided, and is configured to perform the method according to the first aspect or any possible implementation of the first aspect. Specifically, the apparatus includes units configured to perform the method according to the first aspect or any possible implementation of the first aspect.

According to a fourth aspect, a data transmission apparatus is provided, and is configured to perform the method according to the second aspect or any possible implementation of the second aspect. Specifically, the apparatus includes units configured to perform the method according to the second aspect or any possible implementation of the second aspect.

According to a fifth aspect, a data transmission system is provided, and includes the apparatus according to the third aspect or any optional implementation of the third aspect and the at least one apparatus according to the fourth aspect or any optional implementation of the fourth aspect.

According to a sixth aspect, a data transmission apparatus is provided. The apparatus may include a transceiver and a processor, and the terminal device may perform the method according to the first aspect or any optional implementation of the first aspect.

According to a seventh aspect, a data transmission apparatus is provided. The apparatus may include a transceiver and a processor, and the terminal device may perform the method according to the second aspect or any optional implementation of the second aspect.

According to an eighth aspect, a computer readable medium is provided. The computer readable medium stores program code executed by a terminal device, and the program code includes an instruction used to perform the method according to the first aspect or each implementation of the first aspect.

According to a ninth aspect, a computer readable medium is provided. The computer readable medium stores program code executed by a network device, and the program code includes an instruction used to perform the method according to the second aspect or each implementation of the second aspect.

### BRIEF DESCRIPTION OF THE DRAWINGS

FIG. 1 is a schematic diagram of an application scenario according to an embodiment of this application;

FIG. 2 is a schematic diagram of a data transmission method according to an embodiment of this application;

FIG. 3 is a schematic block diagram of a data transmission apparatus according to an embodiment of this application;

FIG. 4 is a schematic block diagram of another data transmission apparatus according to an embodiment of this application;

FIG. 5 is a schematic block diagram of a data transmission system according to an embodiment of this application;

FIG. 6 is a schematic block diagram of a data transmission apparatus according to an embodiment of this application; and

FIG. 7 is a schematic block diagram of another data transmission apparatus according to an embodiment of this application.

### DETAILED DESCRIPTION OF ILLUSTRATIVE EMBODIMENTS

It should be understood that the technical solutions of the embodiments of this application may be applied to various communications systems, such as a Global System for Mobile Communications (GSM) system, a Code Division Multiple Access (CDMA) system, a Wideband Code Division Multiple Access (WCDMA) system, a general packet radio service (GPRS), a Long Term Evolution (LTE) system, an LTE frequency division duplex (, FDD) system, LTE time division duplex (TDD), Universal Mobile Telecommunications System (UMTS), a Worldwide Interoperability for Microwave Access (WiMAX) communications system, a wireless local area network (WLAN), or a future fifth generation (5G) wireless communications system.

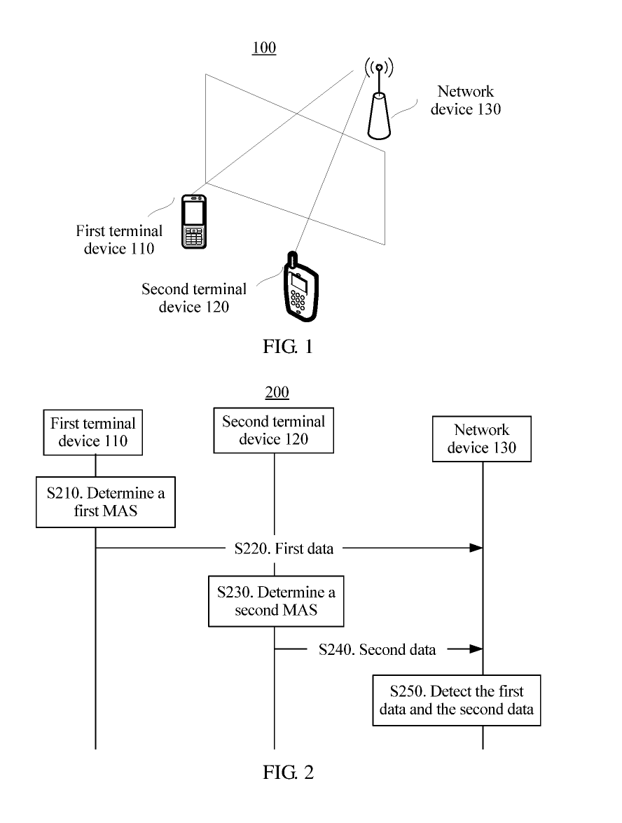

FIG. 1 is a schematic diagram of an application scenario according to an embodiment of this application, including a first terminal device no, configured to generate first data based on a first MAS, and send the first data to a network device 130 on a multiplexing resource (a box in FIG. 1), a second terminal device 120, configured to generate second data based on a second MAS, and send the second data to the network device 130 on the multiplexing resource, and the network device 130, configured to receive, on the multiplexing resource, the first data sent by the first terminal device no and the second data sent by the second terminal device 120.

In the prior art, when the first terminal device no and the second terminal device 120 send the first data and the second data to the network device 130 on the multiplexing resource, the first data and the second data interfere with each other, and the network device 130 cannot well detect the first data and the second data. Consequently, data transmission performance is relatively poor. In this embodiment of this application, the first MAS for generating the first data and the second MAS for generating the second data may include different DMRSs and/or different preamble sequences. In this way, when receiving the first data and the second data on the multiplexing resource, the network device 130 may jointly detect the first data and the second data by using the first MAS and the second MAS, so as to improve data transmission performance.

In this embodiment of this application, the first terminal device no may be a URLLC terminal device, and the second terminal device 120 may be an eMBB terminal device. Alternatively, the first terminal device no may be an eMBB terminal device, and the second terminal device 120 may be a URLLC terminal device. Alternatively, the first terminal device no may be an eMBB terminal device, and the second terminal device 120 may be an eMBB terminal device. Alternatively, the first terminal device no may be a URLLC terminal device, and the second terminal device 120 may be a URLLC terminal device. Devices what the first terminal device no and the second terminal device 120 are specifically are not limited in this embodiment of this application.

It should be understood that in this embodiment of this application, the first terminal device no and the second terminal device 120 may be referred to as user equipment (UE), a terminal device, a mobile station (MS), a mobile terminal, a terminal device in a future 5G network, or the like. The terminal device may communicate with one or more core networks over a radio access network (RAN). For example, the terminal may be a mobile phone (also referred to as a “cellular” phone) or a computer having a mobile terminal. For example, the terminal may be a portable, pocket-sized, handheld, computer built-in, or in-vehicle mobile apparatus, which exchanges voice and/or data with the radio access network.

It should be further understood that the network device 130 may be configured to communicate with a mobile device. The network device 130 may be a base transceiver station (BTS) in GSM or CDMA, or may be a NodeB (NB) in WCDMA, or may be an evolved NodeB (eNB or eNodeB) in LTE, or may be a relay station or an access point, or may be an in-vehicle device, a wearable device, or an access network device in a future 5G network.

FIG. 2 shows a data transmission method 200 according to an embodiment of this application. The method 200 includes the following steps.

S210. A first terminal device no determines a first MAS for sending first data.

In an optional embodiment, before S210, the method 200 includes sending, by the network device 130, second indication information to the first terminal device no, and receiving, by the first terminal device no, the second indication information sent by the network device 130, where the second indication information is used to indicate a first MAS set, and S210 includes determining, by the first terminal device no, the first MAS set according to the second indication information, and determining, by the first terminal device no, the first MAS in the first MAS set. Optionally, the first MAS set may not be indicated by using the second indication information sent by the network device 130, and may be a first MAS set specified in the protocol.

The first terminal device no determines the first MAS in the first MAS set in two manners.

In a first manner, when the first terminal device no works in an authorization mode, the network device 130 sends first indication information to the first terminal device no. The first indication information is used to instruct the first terminal device no to send the data by using the first MAS in the first MAS set. The first terminal device no receives the first indication information sent by the network device 130, and the determining, by the first terminal device no, the first MAS in the first MAS set includes determining, by the first terminal device no, the first MAS in the first MAS set according to the first indication information. Optionally, the first indication information may instruct the first terminal device no to send all data or only the first data by using the first MAS in the first MAS set.

In a second manner, when the first terminal device no works in an authorization-free mode, the first terminal device no determines the first MAS based on identification information of the first terminal device no and a MAS sequence number in the first MAS set. For example, the MAS sequence number in the MAS set may be 0, 1, . . . , and K−1. Assuming that the identification information of the first terminal device no is N, the first terminal device no may select a (mod(N, K))^{th} MAS for access, where mod is a modulo operation. Certainly, the MAS sequence number in the MAS set may also be a frame number, a slot number, a cell ID, or the like.

In an optional embodiment, after the first terminal device no determines the first MAS in the first MAS set, the first terminal device 110 sends a first DMRS and/or a preamble sequence in the first MAS set to the network device 130. The network device 130 receives the first DMRS and/or the first preamble sequence that are/is sent by the first terminal device no.

In an optional embodiment, before S250, the method 200 further includes determining, by the network device 130, the first MAS of the first terminal device no. The determining, by the network device 130, the first MAS of the first terminal device no includes determining, by the network device 130, the first MAS based on the first DMRS and/or the first preamble sequence and a first mapping relationship. The first mapping relationship is used to indicate a correspondence between a MAS and a DMRS and/or a preamble sequence that are/is sent by the first terminal device no.

Specifically, the first terminal device 110 may work in an authorization-free mode, the network device 130 stores the first mapping relationship, and the first mapping relationship indicates the correspondence between a MAS and a DMRS and/or a preamble sequence. When selecting the first MAS, the first terminal device no sends the first DMRS and/or the first preamble sequence in the first MAS to the network device 130. When receiving the first DMRS and/or the first preamble sequence, the network device 130 finds, based on the stored first mapping relationship, the first MAS corresponding to the first DMRS and/or the first preamble sequence. It may be understood that the first mapping relationship is used to indicate a mapping relationship between the first DMRS and the first MAS, or the first mapping relationship is used to indicate a mapping relationship between the first preamble sequence and the first MAS, or the first mapping relationship is used to indicate a mapping relationship between the first preamble sequence as well as the first DMRS and the first MAS. Optionally, the protocol may specify that the first terminal device no uses the first DRMS and/or the first preamble sequence. In this way, when receiving the first DMRS and/or the first preamble sequence, the network device 130 may determine that the first DMRS and/or the first preamble sequence are/is sent by the first terminal device no, and then find the corresponding first MAS based on the first mapping relationship.

In an optional embodiment, before S220, the method 200 further includes determining, by the network device 130, the multiplexing resource, and sending, by the network device 130, fifth indication information to the first terminal device no, where the fifth indication information is used by the first terminal device no to determine the multiplexing resource. Optionally, before S220, the method 200 includes determining, by the first terminal device no, the multiplexing resource, and the determining, by the first terminal device no, the multiplexing resource includes receiving, by the first terminal device no, fifth indication information sent by the network device 130, and determining the multiplexing resource according to the fifth indication information.

In an optional embodiment, the fifth indication information is used to indicate, to the first terminal device no, that a first physical resource is the multiplexing resource.

In an optional embodiment, the first terminal device no can send the data on all physical resources.

Specifically, the fifth indication information may directly indicate, to the first terminal device no, that the first physical resource is the multiplexing resource. When the first terminal device no is an eMBB terminal device, the eMBB terminal device may occupy all the physical resources by default. When receiving the fifth indication information sent by the network device 130, the eMBB terminal device may determine that the first physical resource is the multiplexing resource, and the remaining physical resources other than the first physical resource are dedicated resources of the eMBB terminal device. In this way, the eMBB terminal device may use different coding manners for data sent on the multiplexing resource and data sent on the dedicated resources. For example, the eMBB terminal device may send the data on the multiplexing resource by using one MAS, and send the data on the dedicated resources by using another MAS. A MAS used to send the data on the multiplexing resource is different from a MAS used to send the data on the dedicated resources. Further, the network device 130 may indicate, to the first terminal device no, a MAS used by the second terminal device 120 to send the data on the multiplexing resource. In this way, when selecting a MAS, the terminal device may avoid the MAS of the second terminal device 120, and select a MAS different from that of the second terminal device 120 to send the data.

In an optional embodiment, the fifth indication information is further used to indicate, to the first terminal device no, that a physical resource of the second terminal device 120 is a first physical resource, and indicates that the first terminal device no can send the data by using the physical resource of the second terminal device 120, and the first physical resource is the multiplexing resource.

Specifically, by default, the first terminal device no and the second terminal device 120 may send data by using different resources. The fifth indication information may further indicate, to the first terminal device no, that the physical resource of the second terminal device 120 is the first physical resource, and the fifth indication information may further indicate that the first terminal device no can send the data by using the physical resource of the second terminal device 120, or the fifth indication information may further indicate that the first terminal device no cannot send the data by using the physical resource of the second terminal device 120. In this way, the first terminal device no may determine, according to the fifth indication information, whether to use the physical resource of the second terminal device 120 as the multiplexing resource.

S220. The first terminal device no sends the first data to a network device 130 on a multiplexing resource between the first terminal device no and a second terminal device 120 based on the first MAS, and the network device 130 receives the first data sent by the first terminal device no on the multiplexing resource, where the first data is generated based on the first multiple access signature MAS.

Specifically, that the first data is generated based on the first MAS may be as follows. A MAS in the first MAS set may include different sparse code multiple access (SCMA) codebooks. When the first MAS includes a specific SCMA codebook, the first terminal device no maps bit data to a multi-dimensional modulation symbol based on the SCMA codebook, in other words, the multi-dimensional modulation symbol is the first data. A MAS in the first MAS set may include different pattern division multiple access (PDMA) spread spectrum patterns. When the first MAS includes a specific PDMA, the first terminal device no first maps bit data to a quadrature amplitude modulation (QAM) symbol, and then performs spectrum spreading based on the specific PDMA spread spectrum pattern, to generate the first data. A MAS in the first MAS set may include different multi-user shared access (MUSA) spread spectrum sequences. When the first MAS includes a specific MUSA spread spectrum sequence, the first terminal device no maps bit data to a QAM symbol, and then performs spectrum spreading based on the specific MUSA spread spectrum sequence, to generate the first data. A MAS in the first MAS set may include different interleaver division multiple access (IDMA) interleaver patterns. When the first MAS includes a specific IDMA, the first terminal device no first maps bit data to a QAM symbol, and then performs interleaving based on the specific IDMA interleaver pattern, to generate the first data. A MAS in the first MAS set may include unavailable interleave-grid multiple access (IGMA) interleaver patterns. When the first MAS includes a specific IGMA, the first terminal device no first maps bit data to a QAM symbol, and then performs interleaving based on the specific IGMA interleaver pattern, to generate the first data.

S230. The second terminal device 120 determines a second MAS for sending second data, where the first MAS and the second MAS include different demodulation reference signals DMRSs and/or different preamble sequences.

In an optional embodiment, before S230, the method 200 includes sending, by the network device 130, fourth indication information to the second terminal device 120, where the fourth indication information is used to indicate the second MAS set, and S230 includes determining, by the second terminal device 120, the second MAS set according to the fourth indication information, and determining, by the second terminal device 120, the second MAS in the second MAS set. Optionally, the second MAS set may not be indicated by using the fourth indication information sent by the network device 130, and may be a second MAS set specified in the protocol.

The second terminal device 120 determines the second MAS in the second MAS set in two manners.

In a first manner, the network device 130 sends third indication information to the second terminal device 120, and the third indication information is used to instruct the second terminal device 120 to send the data by using the second MAS in the second MAS set. The second terminal device 120 receives the third indication information sent by the network device 130, and the determining, by the second terminal device 120, the second MAS in the second MAS set includes determining, by the second terminal device 120, the second MAS in the second set according to the second indication information.

In a second manner, the second terminal device 120 determines the second MAS based on identification information of the second terminal device 120 and a MAS sequence number in the second MAS set.

In an optional embodiment, before S250, the method 200 further includes determining, by the network device 130, the second MAS of the second terminal device 120. The determining, by the network device 130, the second MAS of the second terminal device 120 includes determining, by the network device 130, the second MAS based on the second DMRS and/or the second preamble sequence and a second mapping relationship. The second mapping relationship is used to indicate a correspondence between a MAS and a DMRS and/or a preamble sequence that are/is sent by the second terminal device 120.

Specifically, the second terminal device 120 may work in an authorization-free mode, the network device 130 stores the second mapping relationship, and the second mapping relationship indicates the correspondence between a MAS and a DMRS and/or a preamble sequence. When selecting the second MAS, the second terminal device 120 sends the second DMRS and/or the second preamble sequence in the second MAS to the network device 130. When receiving the second DMRS and/or the second preamble sequence, the network device 130 finds, based on the stored second mapping relationship, the second MAS corresponding to the second DMRS and/or the second preamble sequence. It may be understood that the second mapping relationship is used to indicate a mapping relationship between the second DMRS and the second MAS, or the second mapping relationship is used to indicate a mapping relationship between the second preamble sequence and the second MAS, or the second mapping relationship is used to indicate a mapping relationship between the second preamble sequence as well as the second DMRS and the second MAS. Optionally, the protocol may specify that the second terminal device 120 uses the second DRMS and/or the second preamble sequence. In this way, when receiving the second DMRS and/or the second preamble sequence, the network device 130 may determine that the second DMRS and/or the second preamble sequence are/is sent by the second terminal device 120, and then find the corresponding second MAS based on the second mapping relationship.

In an optional embodiment, before S240, the method 200 further includes determining, by the network device 130, the multiplexing resource, and sending, by the network device 130, sixth indication information to the second terminal device 120, where the sixth indication information is used to instruct the second terminal device 120 to determine the multiplexing resource. Optionally, before S240, the method 200 includes determining, by the second terminal device 120, the multiplexing resource, and the determining, by the second terminal device 120, the multiplexing resource includes receiving, by the second terminal device 120, sixth indication information sent by the network device 130, and determining the multiplexing resource according to the sixth indication information.

In an optional embodiment, the sixth indication information is used to indicate, to the second terminal device 120, that the first physical resource is the multiplexing resource.

In an optional embodiment, the second terminal device 120 can send the data on all physical resources.

Specifically, the sixth indication information may directly indicate, to the second terminal device 120, that the first physical resource is the multiplexing resource. The second terminal device 120 may be a URLLC terminal device, and the URLLC terminal device may occupy all the physical resources by default. When receiving the fifth indication information sent by the network device 130, the URLLC terminal device may determine that the first physical resource is the multiplexing resource, and the remaining physical resources other than the first physical resource are dedicated resources of the URLLC terminal device. In this way, the URLLC terminal device may use different coding manners for data sent on the multiplexing resource and data sent on the dedicated resources.

In an optional embodiment, the sixth indication information is used to indicate, to the second terminal device 120, that a physical resource of the first terminal device no is a first physical resource, and indicates that the second terminal device 120 can send the data by using the physical resource of the first terminal device 110, and the first physical resource is the multiplexing resource.

Specifically, by default, the first terminal device no and the second terminal device 120 may send data by using different resources. The sixth indication information may further indicate, to the second terminal device 120, that the physical resource of the first terminal device no is the first physical resource, and the sixth indication information may further indicate that the second terminal device 120 can send the data by using the physical resource of the first terminal device 110, or the sixth indication information may further indicate that the second terminal device 120 cannot send the data by using the physical resource of the first terminal device 110. In this way, the second terminal device 120 may determine, according to the sixth indication information, whether to use the physical resource of the first terminal device no as the multiplexing resource.

S240. The second terminal device 120 sends the second data to the network device 130 on the multiplexing resource based on the second MAS, and the network device 130 receives the second data sent by the second terminal device 120 on the multiplexing resource, where the second data is generated based on the second MAS.

Specifically, that the second data is generated based on the second MAS may be as follows. A MAS in the second MAS set may include different SCMA codebooks. When the second MAS includes a specific SCMA codebook, the second terminal device 120 maps bit data to a multi-dimensional modulation symbol based on the SCMA codebook, in other words, the multi-dimensional modulation symbol is the second data. A MAS in the second MAS set may include different PDMA spread spectrum patterns. When the second MAS includes a specific PDMA, the second terminal device 120 first maps bit data to a QAM symbol, and then performs spectrum spreading based on the specific PDMA spread spectrum pattern, to generate the second data. A MAS in the second MAS set may include different MUSA spread spectrum sequences. When the second MAS includes a specific MUSA spread spectrum sequence, the second terminal device 120 maps bit data to a QAM symbol, and then performs spectrum spreading based on the specific MUSA spread spectrum sequence, to generate the second data. A MAS in the second MAS set may include different IDMA interleaver patterns. When the second MAS includes a specific IDMA, the second terminal device 120 first maps bit data to a QAM symbol, and then performs interleaving based on the specific IDMA interleaver pattern, to generate the second data. A MAS in the second MAS set may include unavailable IGMA interleaver patterns. When the second MAS includes a specific IGMA, the second terminal device 120 first maps bit data to a QAM symbol, and then performs interleaving based on the specific IGMA interleaver pattern, to generate the second data.

S250. The network device 130 detects, based on the first MAS and the second MAS, the first data and the second data that are sent on the multiplexing resource.

In an optional embodiment, S250 includes detecting, by the network device 130 based on the first MAS and the second MAS by using a message passing algorithm MPA, the first data and the second data that are sent on the multiplexing resource. The network device 130 may detect, based on the first MAS and the second MAS by using the MPA, the first data and the second data that are sent on the multiplexing resource, or may certainly detect, by using another algorithm, the first data and the second data that are sent on the multiplexing resource. This is not limited in this embodiment of this application.

For example, when the first terminal device no is an eMBB terminal device, and the second terminal device 120 is a URLLC terminal device, the network device 130 receives a symbol y(t) on a t^{th} resource element (RE), which may be expressed by using the following formula (1):

$$y ( t ) = {\sum }_{i ∈ {C}_{1}} {h}_{i} ( t ) {x}_{i} ( t ) + {\sum }_{j ∈ {C}_{2}} {h}_{j} ( t ) {x}_{j} ( t ) + n ( t ) , \qquad ( 1 )$$

where C₁ and C₂ are respectively codebook numbers of the eMBB terminal device and the URLLC terminal device, hᵢ(t) represents a channel gain of the eMBB terminal device, hⱼ(t) represents a channel gain of the URLLC terminal device, xₜ(t) represents a symbol sent by an i^{th} codebook of the eMBB terminal device on the t^{th} RE, xⱼ (t) represents a symbol sent by a j^{th} codebook of the URLLC terminal device on the t^{th} RE, and n(t) represents noise. Based on the received symbol y(t), the network device 130 determines hⱼ(t) based on the DMRS and/or the preamble sequence that are/is included in the first MAS, determines tⱼ(t) based on the DMRS and/or the preamble sequence that are/is included in the second MAS, and obtains xᵢ(t) and xⱼ(t) based on the MPA or by using another method.

In an optional embodiment, the first terminal device no is an enhanced mobile broadband eMBB terminal device, and the second terminal device 120 is an ultra-reliable and low latency communications URLLC terminal device. In this way, the eMBB terminal device needs to occupy a relatively large quantity of resources while increasing a system capacity, for example, may occupy all the physical resources. When the URLLC terminal device sends data on some physical resources, a DMRS in the MAS used by the eMBB terminal device is different from a DMRS in the MAS used by the URLLC terminal device, and/or a preamble sequence in the MAS used by the eMBB terminal device is different from a preamble sequence in the MAS used by the URLLC terminal device. In this way, the network device 130 may detect the first data and the second data that are received on the multiplexing resource. Therefore, data transmission performance can be improved while a key performance indicator of the URLLC terminal device is met.

It should be understood that a sequence of performing S210, S220, S230, and S240 in the method 200 may not be related to a sequence number. For example, S210 and S220 may be simultaneously performed, and S220 and S240 may be simultaneously performed. In other words, the first terminal device no and the second terminal device 120 may simultaneously send the first data and the second data on the multiplexing resource, and the network device 130 may receive the first data and the second data on the multiplexing resource.

It should be understood that the first MAS set and the second MAS set mentioned in this embodiment of this application each include a plurality of MASs, and each MAS includes a DMRS and/or a preamble sequence and at least one of the following five items, including a codebook (or a codeword), a sequence, an interleaver pattern, a mapping pattern, a spatial dimension, and a power dimension. Each MAS includes different DMRSs and/or different preamble sequences, and elements included in each MAS except the DMRSs and the preamble sequences may be the same or different. This is not limited in this embodiment of this application.

It should be understood that in this embodiment of this application, the first terminal device no may send the first data, or may send the first DMRS and/or the first preamble sequence. The second terminal device 120 may send the second data, or may send the second DMRS and/or the second preamble sequence. Herein, the data sent by either of the terminal devices may be sent together with the DMRS. Alternatively, the data and the DMRS may be separately sent, and the DMRS is sent before the data. Alternatively, the DMRS and the preamble sequence are simultaneously sent before the data. A sending manner is not limited in this embodiment of this application.

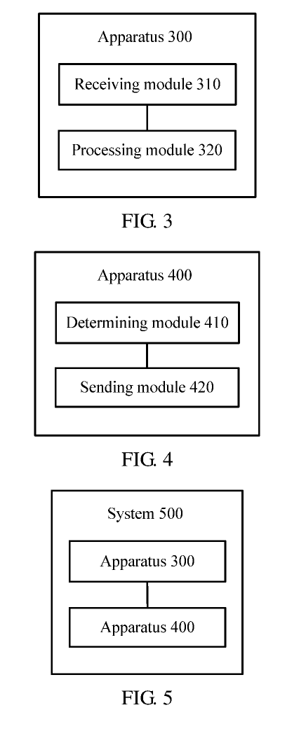

FIG. 3 shows a data transmission apparatus 300 according to an embodiment of this application. The apparatus 300 may be the network device 130 in the method 200, and the apparatus 300 includes a receiving module 310, configured to receive first data sent by a first terminal device no on a multiplexing resource, where the first data is generated based on a first multiple access signature MAS, where the receiving module 310 is further configured to receive second data sent by a second terminal device 120 on the multiplexing resource, where the second data is generated based on a second MAS, and the first MAS and the second MAS include different demodulation reference signals DMRSs and/or different preamble sequences, and a processing module 320, configured to detect, based on the first MAS and the second MAS, the first data and the second data that are sent on the multiplexing resource.

In an optional embodiment, the processing module 320 is further configured to determine the first MAS of the first terminal device before the first data sent by the first terminal device no on the multiplexing resource is received.

In an optional embodiment, the receiving module 310 is further configured to receive a first DMRS and/or a first preamble sequence that are/is sent by the first terminal device no, and the processing module 320 is specifically configured to determine the first MAS based on the first DMRS and/or the first preamble sequence and a first mapping relationship, where the first mapping relationship is used to indicate a correspondence between a MAS and a DMRS and/or a preamble sequence that are/is sent by the first terminal device no.

In an optional embodiment, the apparatus 300 further includes a first sending module, configured to send first indication information to the first terminal device no, where the first indication information is used to instruct the first terminal device no to send the data by using the first MAS in a first MAS set.

In an optional embodiment, the first sending module is configured to send second indication information to the first terminal device 110 before sending the first indication information to the first terminal device no, where the second indication information is used to indicate the first MAS set.

In an optional embodiment, the processing module 320 is further configured to determine the second MAS of the second terminal device 120 before the second data sent by the second terminal device 120 on the multiplexing resource is received.

In an optional embodiment, the receiving module 310 is further configured to receive a second DMRS and/or a second preamble sequence that are/is sent by the second terminal device 120, and the processing module 320 is further specifically configured to determine the second MAS based on the second DMRS and/or the second preamble sequence and a second mapping relationship, where the second mapping relationship is used to indicate a correspondence between a MAS and a DMRS and/or a preamble sequence that are/is sent by the second terminal device 120.

In an optional embodiment, the apparatus 300 further includes a second sending module, configured to send third indication information to the second terminal device 120, where the third indication information is used to instruct the second terminal device 120 to send the data by using the second MAS in a second MAS set.

In an optional embodiment, the second sending module is further configured to send fourth indication information to the second terminal device 120 before sending the third indication information to the second terminal device 120, where the fourth indication information is used to indicate the second MAS set.

In an optional embodiment, the processing module 320 is further configured to determine the multiplexing resource before the first data sent by the first terminal device 110 on the multiplexing resource is received, and the apparatus further includes a third sending module, configured to send fifth indication information to the first terminal device 110, where the fifth indication information is used by the first terminal device 110 to determine the multiplexing resource, and/or the third sending module is further configured to send sixth indication information to the second terminal device 120, where the sixth indication information is used to instruct the second terminal device 120 to determine the multiplexing resource.

In an optional embodiment, the fifth indication information is used to indicate, to the first terminal device no, that a first physical resource is the multiplexing resource, and the sixth indication information is used to indicate, to the second terminal device 120, that the first physical resource is the multiplexing resource.

In an optional embodiment, the first terminal device no can send the data on all physical resources, and/or the second terminal device 120 can send the data on all physical resources.

In an optional embodiment, the fifth indication information is further used to indicate, to the first terminal device no, that a physical resource of the second terminal device 120 is a first physical resource, and indicates that the first terminal device no can send the data by using the physical resource of the second terminal device 120, and the first physical resource is the multiplexing resource.

In an optional embodiment, the sixth indication information is used to indicate, to the second terminal device 120, that a physical resource of the first terminal device no is a first physical resource, and indicates that the second terminal device 120 can send the data by using the physical resource of the first terminal device no, and the first physical resource is the multiplexing resource.

In an optional embodiment, the processing module 320 is further specifically configured to detect, based on the first MAS and the second MAS by using a message passing algorithm MPA, the first data and the second data that are sent on the multiplexing resource. [0130] In an optional embodiment, the first terminal device no is an enhanced mobile broadband eMBB terminal device, and the second terminal device 120 is an ultra-reliable and low latency communications URLLC terminal device.

FIG. 4 shows a data transmission apparatus 400 according to an embodiment of this application. The apparatus 400 may be the first terminal device no or the second terminal device 120 in the method 200, and the apparatus 400 includes a determining module 410, configured to determine a first multiple access signature MAS for sending first data, and a sending module 420, configured to send the first data to a network device 130 on a multiplexing resource between the apparatus and a second terminal device 120 based on the first MAS, where a second MAS of the second terminal device 120 and the first MAS include different demodulation reference signals DMRSs and/or different preamble sequences.

In an optional embodiment, the apparatus 400 further includes a first receiving module, configured to before the first multiple access signature MAS for sending the first data is determined, receive second indication information sent by the network device 130, where the second indication information is used to indicate a first MAS set, and the determining module 420 is specifically configured to determine the first MAS set according to the second indication information, and determine the first MAS in the first MAS set.

In an optional embodiment, the first receiving module is further configured to receive first indication information sent by the network device 130, where the first indication information is used by the apparatus to send the data by using the first MAS in the first MAS set, and the determining module 420 is further specifically configured to determine the first MAS in the first MAS set according to the first indication information.

In an optional embodiment, the determining module 420 is further specifically configured to determine the first MAS based on identification information of the apparatus 400 and a MAS sequence number in the first MAS set.

In an optional embodiment, the determining module 420 is further configured to determine the multiplexing resource before the first data is sent to the network device 130 on the multiplexing resource between the apparatus and the second terminal device 120 based on the first MAS.

In an optional embodiment, the apparatus 400 further includes a second receiving module, configured to receive fifth indication information sent by the network device 130, and the determining module 420 is further specifically configured to determine the multiplexing resource according to the fifth indication information.

In an optional embodiment, the fifth indication information is used to indicate, to the apparatus, that a first physical resource is the multiplexing resource, and the determining module 420 is further specifically configured to determine, according to the fifth indication information, that the first physical resource is the multiplexing resource.

In an optional embodiment, the apparatus 400 can send the data on all physical resources, and/or the second terminal device 120 can send data on all physical resources.

In an optional embodiment, the fifth indication information is further used to indicate, to the apparatus 400, that a physical resource of the second terminal device 120 is a first physical resource, and indicates that the apparatus 400 can send the data by using the physical resource of the second terminal device 120, and the first physical resource is the multiplexing resource.

In an optional embodiment, the apparatus 400 is an enhanced mobile broadband eMBB terminal device, and the second terminal device 120 is an ultra-reliable and low latency communications URLLC terminal device.

In an optional embodiment, the apparatus 400 is a URLLC terminal device, and the second terminal device 120 is an eMBB terminal device.

FIG. 5 shows a data transmission system 500 according to an embodiment of this application. The system 500 includes the apparatus 300 and the apparatus 400.

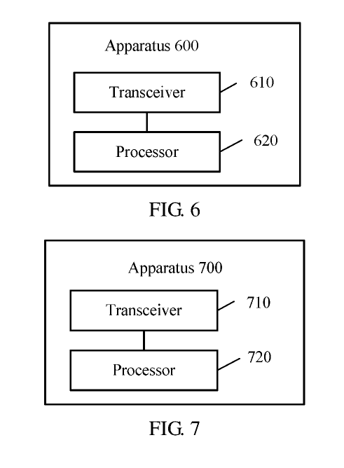

FIG. 6 is a schematic block diagram of a data transmission apparatus 600 according to an embodiment of this application. For example, the apparatus may be the network device 130 in the method 100. The apparatus 600 includes a transceiver 610 and a processor 620.

The transceiver 610 is configured to receive first data sent by a first terminal device no on a multiplexing resource, where the first data is generated based on a first multiple access signature MAS. The transceiver 610 is further configured to receive second data sent by a second terminal device 120 on the multiplexing resource, where the second data is generated based on a second MAS, and the first MAS and the second MAS include different demodulation reference signals DMRSs and/or different preamble sequences. The processor 620 is configured to detect, based on the first MAS and the second MAS, the first data and the second data that are sent on the multiplexing resource.

It should be understood that the apparatus 600 may correspond to the network device 130 in the method 200, and may implement corresponding functions of the network device 130 in the method 200. For brevity, details are not described herein again.

FIG. 7 is a schematic block diagram of a data transmission apparatus 700 according to an embodiment of this application. The apparatus may be the first terminal device no or the second terminal device 120 in the method 200. As shown in FIG. 7, the apparatus 700 includes a transceiver 710 and a processor 720.

The processor 720 is configured to determine a multiple access signature MAS for sending first data. The transceiver 710 is configured to send the first data to a network device 130 on a multiplexing resource between the apparatus and a second terminal device 120 based on the first MAS, where a second MAS of the second terminal device 120 and the first MAS include different demodulation reference signals DMRSs and/or different preamble sequences.

It should be understood that the apparatus 700 may correspond to the first terminal device 110 or the second terminal device 120 in the method 200, and may implement corresponding functions of the first terminal device no and the second terminal device 120 in the method 200. For brevity, details are not described herein again.

It should be understood that in the embodiments of this application, the processor 620 and the processor 720 may be a central processing unit (central processing unit, CPU), or the processor may be another general purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor may be a microprocessor, or the processor may be any conventional processor or the like.

It should be understood that the term “and/or” in this specification describes only an association relationship for describing associated objects and represents that three relationships may exist. For example, A and/or B may represent the following three cases. Only A exists, both A and B exist, and only B exists. In addition, the character “/” in this specification generally indicates an “or” relationship between the associated objects.

It should be understood that sequence numbers of the foregoing processes do not mean execution sequences in various embodiments of this application. The execution sequences of the processes should be determined according to functions and internal logic of the processes, and should not be construed as any limitation on the implementation processes of the embodiments of this application.

A person of ordinary skill in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments in this application.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the embodiments of this application essentially, or the part contributing to the prior art, or all or some of the technical solutions may be implemented in the form of a software product. The computer software product is stored in a storage medium and includes several indications for instructing a computer device (which may be a personal computer, a server, or a network device) to perform all or some of the steps of the methods described in the embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific embodiments of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

What is claimed is:

1. A data transmission method, comprising:
receiving, by a network device, first data sent by a first terminal device on a multiplexing resource, wherein the first data is generated according to a first multiple access signature (MAS);
receiving, by the network device, second data sent by a second terminal device on the multiplexing resource, wherein the second data is generated according to a second MAS, and wherein the first MAS and the second MAS have at least one of different demodulation reference signals (DMRSs) or different preamble sequences; and
detecting, by the network device, from the multiplexing resource, according to the first MAS and the second MAS, the first data and the second data that are sent on the multiplexing resource.

2. The method according to claim 1, wherein the method further comprises determining, by the network device, the first MAS of the first terminal device before the receiving the first data, wherein the determining the first MAS of the first terminal device comprises:
receiving, by the network device, at least one of a first DMRS or a first preamble sequence sent by the first terminal device; and
determining, by the network device, the first MAS according to the at least one of the first DMRS or the first preamble sequence and further according to a first mapping relationship, wherein the first mapping relationship indicates a correspondence between a MAS and a at least one of a DMRS or a preamble sequence sent by the first terminal device.

3. The method according to claim 1, wherein the method further comprises:
sending, by the network device, to the first terminal device, first indication information, wherein the first indication information instructs the first terminal device to send the data by using the first MAS in a first MAS set; and
sending, by the network device, before the sending the first indication information to the first terminal device, second indication information to the first terminal device, wherein the second indication information indicates the first MAS set.

4. The method according to claim 3, wherein the method further comprises determining, by the network device, the second MAS of the second terminal device before the receiving the second data sent by the second terminal device, wherein the determining, by the network device, the second MAS of the second terminal device comprises:
receiving, by the network device, at least one of a second DMRS or a second preamble sequence sent by the second terminal device; and
determining, by the network device, the second MAS according to the at least one of the second DMRS or the second preamble sequence and further according to a second mapping relationship, wherein the second mapping relationship indicates a correspondence between a MAS and at least one of a DMRS or a preamble sequence sent by the second terminal device.

5. The method according to claim 1, wherein the method further comprises:
sending, by the network device, fourth indication information to the second terminal device, wherein the fourth indication information indicates a second MAS set; and
sending, by the network device, after sending the fourth indication information, third indication information to the second terminal device, wherein the third indication information instructs the second terminal device to send the data by using the second MAS in the second MAS set.

6. The method according to claim 1, wherein the method further comprises performing, before the receiving the first data sent by the first terminal device:
determining, by the network device, the multiplexing resource; and
performing at least one of:
sending, by the network device, fifth indication information to the first terminal device, wherein the fifth indication information is used by the first terminal device to determine the multiplexing resource; or
sending, by the network device, sixth indication information to the second terminal device, wherein the sixth indication information is used by the second terminal device to determine the multiplexing resource.

7. A data transmission method, comprising:
determining, by a first terminal device, a first multiple access signature (MAS) for sending first data; and
sending, by the first terminal device, according to the first MAS, the first data to a network device on a multiplexing resource used for transmission to the network device by the first terminal device and by a second terminal device, wherein a second MAS of the second terminal device and the first MAS have at least one of different demodulation reference signals (DMRSs) or different preamble sequences.

8. The method according to claim 7, wherein the method further comprises performing, before the determining the first MAS:
receiving, by the first terminal device, second indication information sent by the network device, wherein the second indication information indicates a first MAS set; and
wherein the determining the first MAS comprises:
determining, by the first terminal device, the first MAS set according to the second indication information; and
determining, by the first terminal device, the first MAS in the first MAS set.

9. The method according to claim 8, wherein the determining the first MAS in the first MAS set comprises:
receiving, by the first terminal device, first indication information sent by the network device, wherein the first indication information is used by the first terminal device to send the data using the first MAS in the first MAS set; and
determining, by the first terminal device, the first MAS in the first MAS set according to the first indication information.

10. The method according to claim 8, wherein the determining the first MAS in the first MAS set comprises:
determining, by the first terminal device, the first MAS according to identification information of the first terminal device and a MAS sequence number in the first MAS set.

11. The method according to claim 7, wherein the method further comprises performing, before the sending the first data:
determining, by the first terminal device, the multiplexing resource according to fifth indication information.

12. The method according to claim 11, wherein the fifth indication information indicates, to the first terminal device, that a first physical resource is the multiplexing resource.

13. The method according to claim 11, wherein the fifth indication information indicates, to the first terminal device, that a physical resource of the second terminal device is a first physical resource, and further indicates that the first terminal device can send the data by using the physical resource of the second terminal device, and wherein the first physical resource is the multiplexing resource.

14. A data transmission apparatus, wherein the apparatus comprises:
a receiving module;
a processor; and
a non-transitory computer-readable storage medium storing a program to be executed by the processor, the program including instructions to:
cause the receiving module to receive first data sent by a first terminal device on a multiplexing resource, wherein the first data is generated according to a first multiple access signature (MAS);
cause the receiving module to receive second data sent by a second terminal device on the multiplexing resource, wherein the second data is generated according to a second MAS, and wherein the first MAS and the second MAS have at least one of different demodulation reference signals (DMRSs) or different preamble sequences; and
detect, from the multiplexing resource, according to the first MAS and the second MAS, the first data and the second data that are sent on the multiplexing resource.

15. The apparatus according to claim 14, wherein the program further includes instructions to:
determine the first MAS of the first terminal device before the first data sent by the first terminal device on the multiplexing resource is received;
cause the receiving module to receive at least one of a first DMRS or a first preamble sequence that are/is sent by the first terminal device; and
determine the first MAS according to the at least one of first DMRS or the first preamble sequence and further according to a first mapping relationship, wherein the first mapping relationship indicates a correspondence between a MAS and at least one of a DMRS or a preamble sequence sent by the first terminal device.

16. The apparatus according to claim 14, wherein the apparatus further comprises a first sending module; and
wherein the program further includes instructions to:
cause the first sending module to send first indication information to the first terminal device, wherein the first indication information instructs the first terminal device to send the data using the first MAS in a first MAS set; and
cause the first sending module to send second indication information to the first terminal device before sending the first indication information to the first terminal device, wherein the second indication information is used to indicate the first MAS set.

17. The apparatus according to claim 14, wherein the wherein the program further includes instructions to:
determine the second MAS of the second terminal device before the second data sent by the second terminal device on the multiplexing resource is received.

18. The apparatus according to claim 17, wherein the program further includes instructions to:
cause the receiving module to receive at least one of a second DMRS or a second preamble sequence sent by the second terminal device; and
determine the second MAS according to the at least one of the second DMRS or the second preamble sequence and further according to a second mapping relationship, wherein the second mapping relationship indicate a correspondence between a MAS and at least one of a DMRS or a preamble sequence sent by the second terminal device.

19. The apparatus according to claim 14, wherein the apparatus further comprises a second sending module; and
wherein the program further includes instructions to:
cause the second sending module to send fourth indication information to the second terminal device, wherein the fourth indication information indicates a second MAS set; and
cause the sending module to send third indication information to the second terminal device after sending the fourth indication information, wherein the third indication information instructs the second terminal device to send the data by using the second MAS in the second MAS set.

20. The apparatus according to claim 14, wherein the apparatus further comprises a third sending module; and
wherein the program further includes instructions to:
determine the multiplexing resource before the first data sent by the first terminal device on the multiplexing resource is received; and
perform at least one of:
cause the third sending module to send fifth indication information to the first terminal device, wherein the fifth indication information is used by the first terminal device to determine the multiplexing resource; or
cause the third sending module to send sixth indication information to the second terminal device, wherein the sixth indication information is used by the second terminal device to determine the multiplexing resource.
